(19) United States
(12) Patent Application Publication
(10) Pub. No.: US 2015/0147738 A1
(43) Pub. Date: May 28, 2015

(54) METHODS AND SYSTEMS FOR TEACHING BIOLOGICAL PATHWAYS

(71) Applicant: BOWLING GREEN STATE UNIVERSITY, BOWLING GREEN, OH (US)

(72) Inventor: NEOCLES BASIL LEONTIS, BOWLING GREEN, OH (US)

(21) Appl. No.: 14/209,989

(22) Filed: Mar. 13, 2014

Related U.S. Application Data
(60) Provisional application No. 61/780,760, filed on Mar. 13, 2013.

(51) Int. Cl. G09B 23/00; G09B 5/00

(52) U.S. Cl. CPC G09B 23/00; G09B 5/00
USPC 434/295

(57) ABSTRACT

Described herein is an educational tool designed to teach a learner about biological pathways. The tool, in the form of an interactive learning module, allows a user to choose how to allocate limited resources. These allocation choices then have consequences, which result in a learner progressing closer to his or her goal or regressing further from the goal. In this fashion, the learner can learn, through trial and error, what resource allocation is optimal for reaching the goal.

### RELATED APPLICATIONS

This application is claiming the benefit, under 35 U.S.C. §119(e), of the provisional application filed on Mar. 13, 2013, under 35 U.S.C. §111(b), which was granted Ser. No. 61/780,760, and is hereby incorporated by reference in its entirety.

### FIELD OF THE INVENTION

The present invention relates to methods and systems for teaching biological pathways.

### BACKGROUND OF THE INVENTION

Biological pathways and interactions are exceptionally complex. They involve production and use of various resources. The production or use of a first resource, can affect the production and use of a second resource, and so on. Many feedback loops and overlap can exist amongst and between various biological pathways.

Described herein is an educational tool designed to teach a learner about biological pathways. Such pathways are traditionally taught by asking a learner to memorize the pathways. Being able to interact with, and test variations of, the pathways will enhance learning and understanding by the learner.

Because of the complex nature of the material, rote memorization is going to be less effective as a learning tool than an interactive learning module as described herein. In addition, rote memorization fails to ensure comprehension of the complexity and the interplay of the various biological activities. It is therefore an object of the current invention to provide an interactive learning module to assist a learner in familiarizing him- or her-self with biological pathways, how they interact, the resources involved in the pathways, and how various resource allocations can affect the pathways and their interactions.

### SUMMARY OF THE INVENTION

The present invention is directed toward a method of teaching biological pathways by providing a learner with one or more resources, one or more pathways, and one or more goals; establishing an initial amount of the one or more resources, a cost of the one or more resources needed to operate the one or more pathways, a product of the one or more pathways, and an effect the one or more pathways on the one or more goals, and then by allowing the leaner to allocate the one or more resources to the one or more pathways, and finally, providing feedback to the learner regarding the one or more goals as a result of the learner's allocation of the one or more resources.

The method may also include adjusting the initial amount of the one of more resources based on the learner's allocation of the one or more resources to provide a resulting amount of one or more resources. Further still the method may include adjusting the initial amount of the one or more resources based on a product of the one or more pathways.

In some embodiments, the steps, or certain steps, of the method may be repeated a predetermined number of times. In other embodiments, points can be donated to a learner when the learner achieves the one or more goals.

The method may involve metabolic pathways globally or of the brain, liver, muscle, or adipose tissue. The method may also involve goals such as protein synthesis, RNA synthesis, glycogen synthesis, ions pumped, muscles contracted, or TAG synthesis. The method may also include resources such as nutrients, sugars, amino acids, fatty acids, O₂, CO₂, H₂O, light, ADP, ATP, Pi, NAD+, NADH, FAD, FADH2, NADP+, NADPH, HS-Coenzyme A, acetyl-S-CoA, G-6-P, glycerol-3-P, palmitate-S-CoA, tri-acyl-glyceride, pyruvate, or R-5-P.

The method may include the one or more resources, the one or more products, the one or more pathways, or the one or more goals being represented by or on one or more physical objects, such as cards, tokens, models, and the like.

The invention also includes a system for teaching biological pathways. The system includes a computer readable medium or media having stored thereon instructions suitably programmed to establish, an initial amount of one or more resources, a cost of the one or more resources needed to operate one or more pathways, a product of one or more pathways, and an effect the one or more pathways on one or more goals.

The computer readable medium or media may be connected to a server.

The system may have means for allowing a leaner to allocate the one or more resources to the one or more pathways. The system may also have instructions suitably programmed to provide feedback to the learner regarding the one or more goals as a result of the learner's allocation of the one or more resources.

In the system of the invention, the learner may allocate resources remotely from the computer readable medium or media. The learner may allocate resources wirelessly.

The system may involve metabolic pathways globally or of the brain, liver, muscle, or adipose tissue. The system may also involve goals such as protein synthesis, RNA synthesis, glycogen synthesis, ions pumped, muscles contracted, or TAG synthesis. The system may also include resources such as nutrients, sugars, amino acids, fatty acids, O₂, CO₂, H₂O, light, ADP, ATP, Pi, NAD+, NADH, FAD, FADH2, NADP+, NADPH, HS-Coenzyme A, acetyl-S-CoA, G-6-P, glycerol-3-P, palmitate-S-CoA, tri-acyl-glyceride, pyruvate, or R-5-P.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic of many known metabolic pathways.

FIG. 2 is a schematic of a pathway in accordance with an embodiment of the invention.

FIG. 3 is a schematic of another type of pathway in accordance with an alternative embodiment of the invention.

FIG. 4 is a schematic of yet another pathway in accordance with yet another embodiment of the invention.

FIG. 5 is a screen shot of a computer-based embodiment of one manifestation of the invention.

### DETAILED DESCRIPTION OF PARTICULAR EMBODIMENTS

The use of the word “or” in this description is used conjunctively to mean one of the series, or any combination thereof, unless specifically stated otherwise. The use of a singular noun is to be construed as including the plural thereof, unless specifically stated otherwise. Likewise, the use of a plural noun is to be construed as including the singular thereof, unless specifically stated otherwise.

The invention includes methods and systems for teaching a learner about biological processes. The biological processes contemplated for use with the methods and systems described herein can include, but Is not limited to, metabolic pathways or their interactions with each other or other processes, organ systems or their interactions with each other or other processes, macro-ecology, micro-ecology, ecosystems or their interactions with each other or other processes, organisms or their interactions with each other or other processes, or metabolic diseases or their interactions with each other or other processes, or any combination thereof.

The ecosystems, components, interactions, pathways or resources involved in various embodiments of the invention described herein are those known in the art. For example, Ecology: From Individuals to Ecosystems, 4th ed., (Michael Begon, Coin R. Townsend, and John L. Harper, Wiley-Blackwell, NY, 2005) is a particularly relevant source of detailed information regarding ecology and is hereby incorporated by reference in its entirety to the extent permitted by law. Another particularly relevant source of detailed information regarding ecology is Microbial Ecology, Larry L. Burton and Diana E. Northup, Wiley-Blackwell, NY, 2011), which is hereby incorporated by reference in its entirety to the extent permitted by law. Still another particularly relevant source of detailed information regarding ecology is Parasitism: The diversity and Ecology of Animal Parasites, 2^{nd} ed., Timothy M. Goater, Cameron P. Goater, and Gerald W Esch, Cambridge University Press, 2013), which is hereby incorporated by reference in its entirety to the extent permitted by law.

The metabolic diseases, components, or resources involved in various embodiments of the invention described herein are those known in the art. For example, Principles of Metabolism in Health and Disease, (Eckhard Lammert and Martin Zeeb, eds., Springer, NY, 2014) is a particularly relevant source of detailed information regarding metabolic diseases and is hereby incorporated by reference in its entirety to the extent permitted by law. Another particularly relevant source of detailed information regarding metabolism and metabolic diseases is Oxford Textbook of Medicine, vol. 1-3, 5^{th} ed., David A. Warrell, Timothy M. Cox, and John D. Firth, Oxford University Press, USA, 2010), which is hereby incorporated by reference in its entirety to the extent permitted by law.

The metabolic pathways, components, or resources involved in various embodiments of the invention described herein are those known in the art. For example, Lehninger Principles of Biochemistry, 6th ed., (David L. Nelson and Michael M. Cox, W.H. Freeman & Co., NY, 2013) is a particularly relevant source of detailed information regarding metabolism and is hereby incorporated by reference in its entirety to the extent permitted by law.

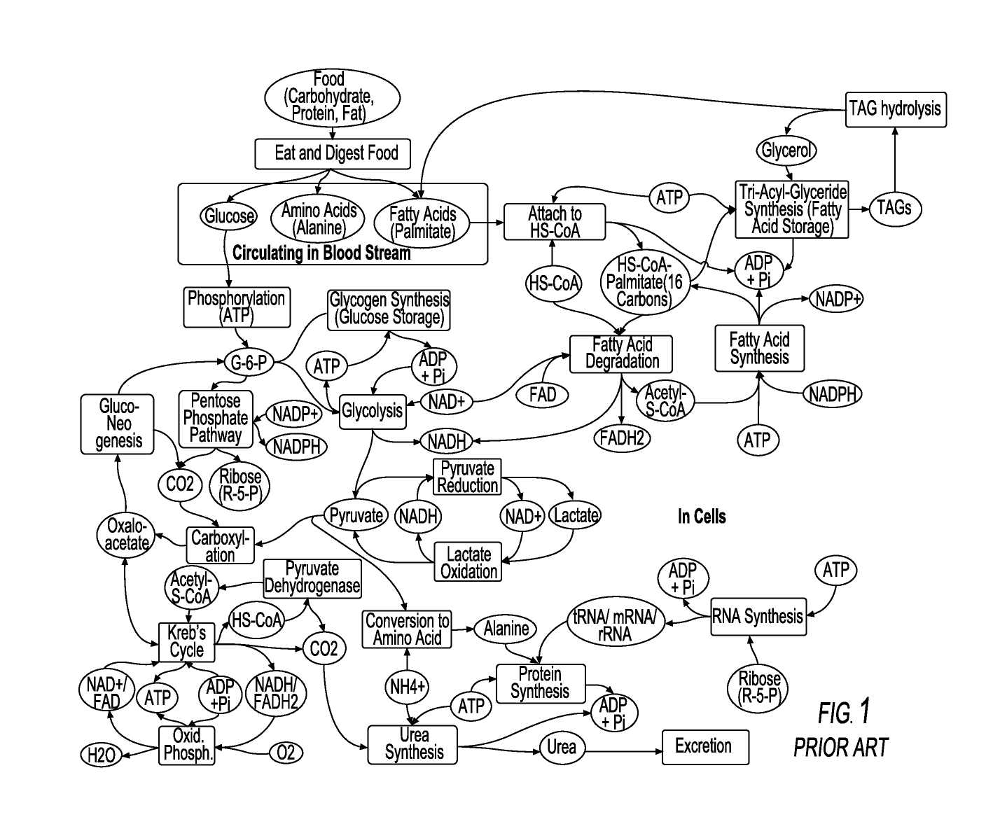

In order to aid learners in comprehending the myriad of metabolic pathways, a sample of which is provided in FIG. 1, their components, and how those pathways and components interact with one another, either directly or indirectly, an interactive learning module is described herein. Similar information is known by those in the art for other embodiments of the invention. One such alternative embodiment is to teach ecosystems of interacting organisms, for example, but not limited to, microbes that use complementary metabolic pathways to live together; where waste products from one organism can be the resources for other organisms. Another alternative embodiment is to teach the effect disease other external pressures may have on the pathways and interactions. For one non-limiting example, the method and systems of the invention can be designed to show the effects of a disease like metabolic syndrome or how choices made by the learner can affect the outcome of metabolism in normal versus diseased states. Similarly, other pressures can be designed into the methods and systems of the invention to show the effects these pressures can have on the learner's ability to reach goals in accordance with the invention. Such pressures may include, but are not limited to, lack of oxygen, need for more oxygen, an influx of a chemical or molecule, or reduction in same, need for increased liver or brain or muscular function, or any known pressure that can have an effect on the biological pathway or interaction being studied by the learner.

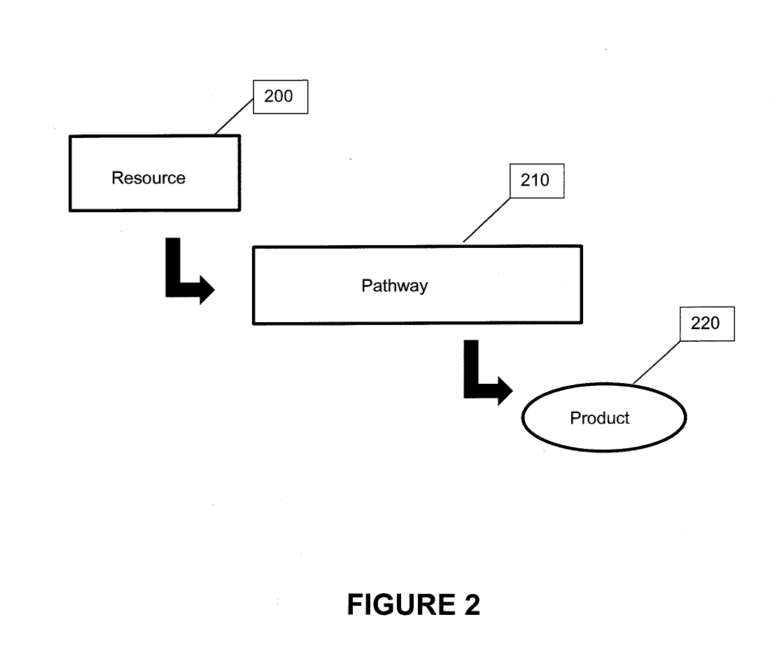

As shown in FIG. 2, a particular resource 200 is used by a particular pathway 210 and through biological processes, various products 220 are produced. By controlling the amount of resources 200 available for a particular pathway 210, the learner can control the amount or possibly the type of products 220 produced.

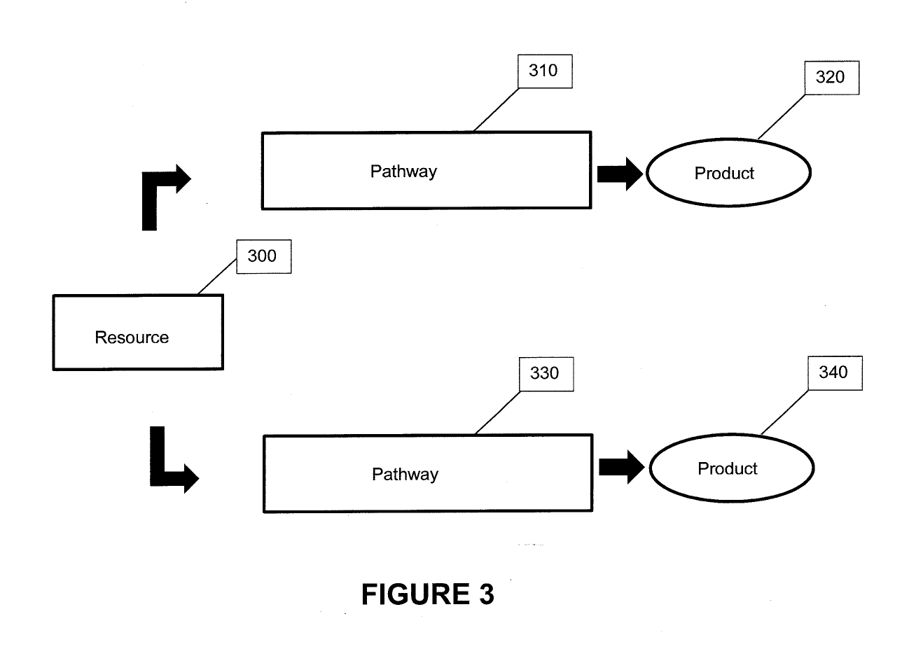

Increasing levels of complexity can be added in the game. One example is shown in FIG. 3, which shows a single resource 300 that is used by two distinct pathways, a first pathway 310 which produces a first product 320 and a second pathway 330 which produces a second product 340. Here, when a leaner chooses to utilize the resource 300 to fund the first pathway 310, the level of the first product 320 will increase, but the second product 340 will not.

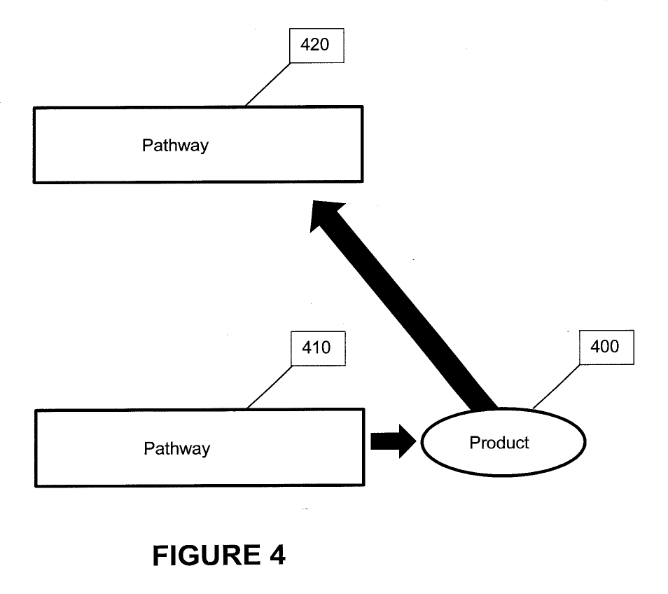

Another example, as shown in FIG. 4, of the type of interaction that can be included in the game is one where the product 400 of a first pathway 410 can influence the activity of a second pathway 420. One non-limiting example of how this influence may be mediated is if the product 400 can act as a resource for a second pathway 420, but any biological possibility can be represented.

As stated before, and is well known in the art, biological pathways are extremely complex. Above are descriptions of simplified pathways that can be used in accordance with the invention. However, numerous other types of pathways and interactions can be used without departing from the scope of the invention. The level of complexity of pathways used in the learning module is limited only by the limits of scientific knowledge regarding the true-life biology of these pathways. For practicality, pathways known to be complex may be simplified as a designer of a manifestation of a learning module in accordance with the invention sees fit. Other aspects of the science upon which the learning module is based may be ignored, altered, or simplified as is desired by the designer.

One reason for encouraging such flexibility in the module is to provide an opportunity to introduce the learner to different levels of complexity as is needed. For example, a high school student will likely want to be exposed to a lower level of complexity than a graduate student in biochemistry. In addition, a lower level of complexity may be ideal for a learner just beginning the study of biological pathways so as to not feel overwhelmed. As that learner becomes more comfortable with the subject, the module can then be adjusted to add levels of complexity.

The module may be presented in the form of a game. The game may have various goals, for example, but not limited to, staying alive, increasing liver function to accommodate a night of heavy drinking, or maintaining homeostasis, or the like. Alternatively, the goals may be more at a cellular or chemical level, for example, but not limited to, increasing RNA synthesis in the brain. The learner will attempt to reach these goals by adjusting the amount of resources available to a particular pathway.

In one embodiment, the game may be a game played with cards or chips or other physical representations of resources and products. In another embodiment, the game may be computer based. Computer based also includes, but is not limited to, web-based, or network based. In web-based or network -based embodiments, the game program may be stored on a server remote to the learner. Alternatively, the learner could also download the program from a remote server to a personal machine, such as a laptop or mobile device such as a smart phone or any other technology available.

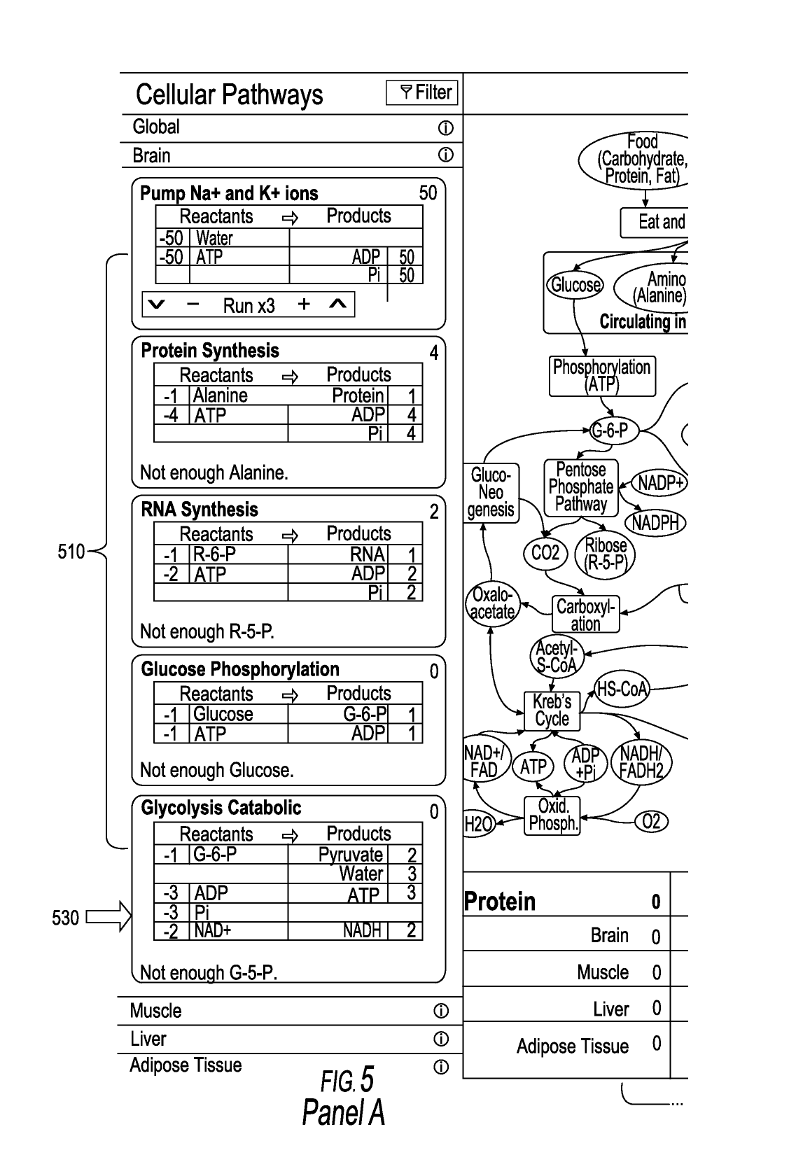

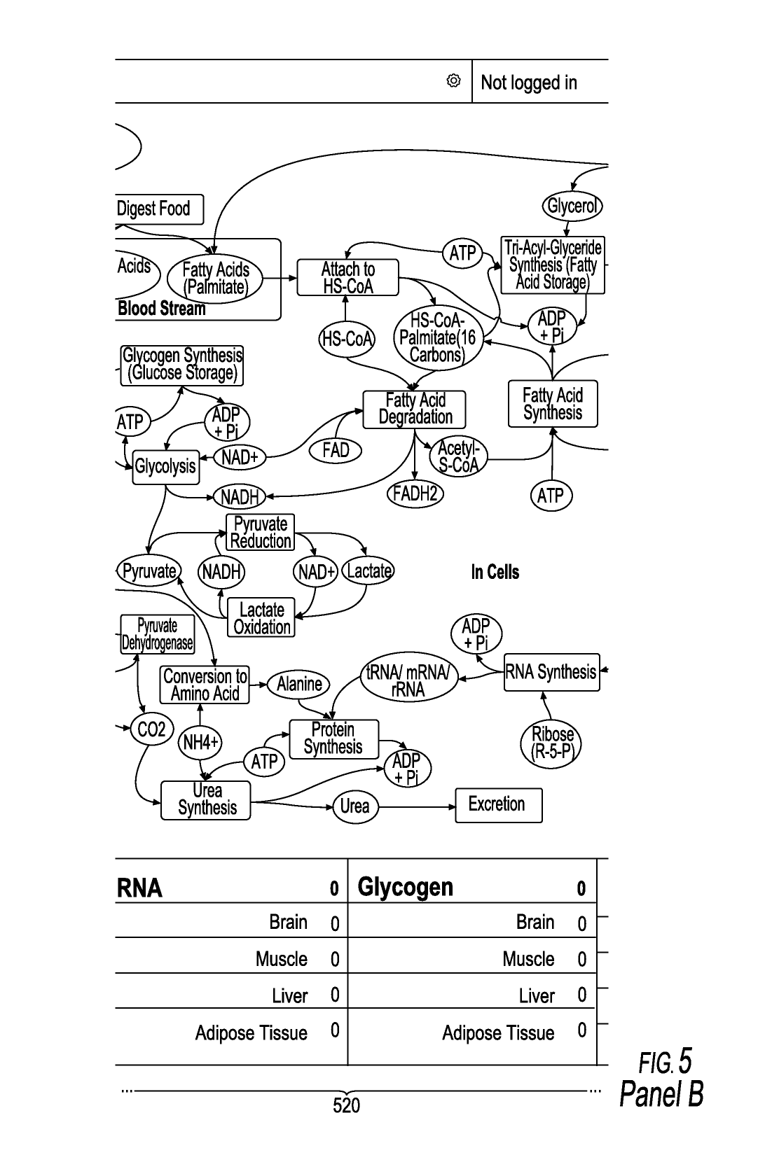

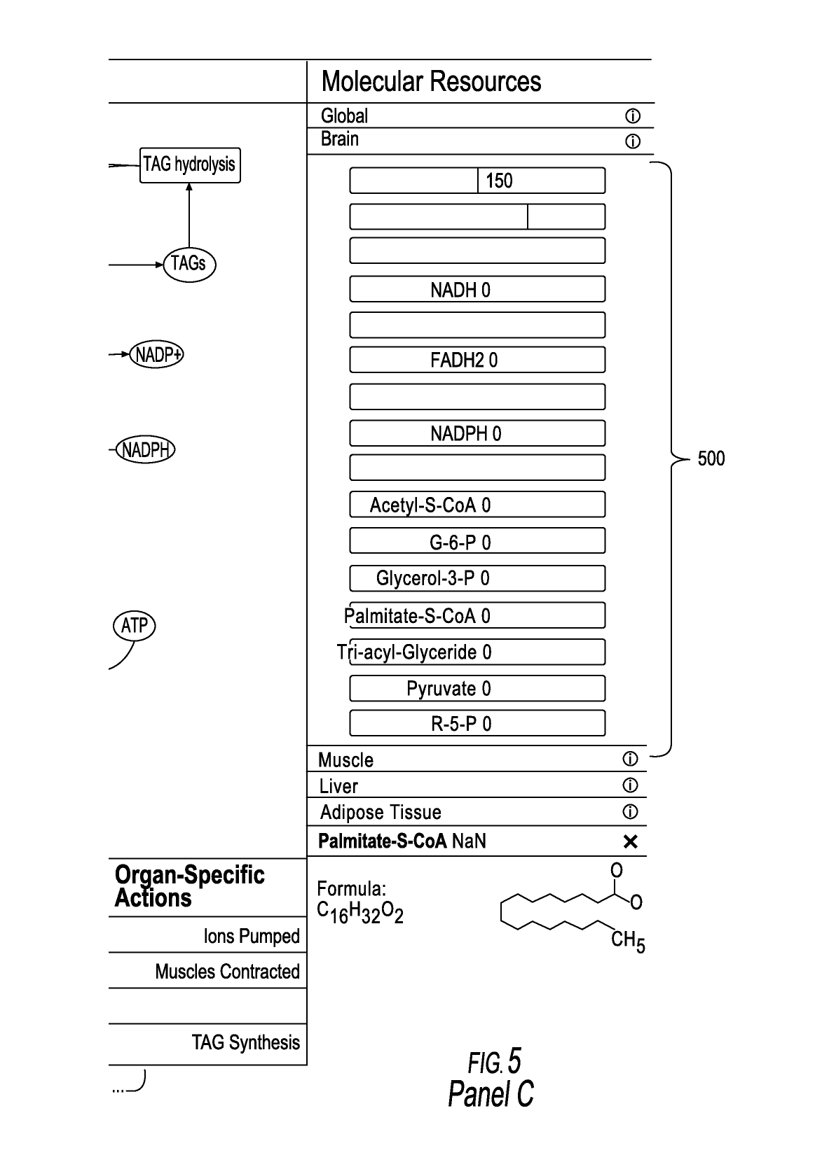

A screen shot from a computer game in accordance with one embodiment of the invention is shown in FIG. 5. FIG. 5, although specifically showing a computer-based embodiment involving metabolism, also shows the basic premise of how a learning module in accordance with the present invention may work. See http://www.metabolismfun.com for further examples. Resources 500 can be spent to use one of the available pathways 510 in order to achieve various goals 520. The resources 510 available, the pathways 510 involved, the costs 530 of using a pathway and the goals 520 to be achieved can all be manipulated by the designer of the game. The learner, within the constraints designed in to the game by the designer, can then decide what resources 510 to use for what pathway 510 and learn through trial and error what goals 520 can or cannot be met.

In the computer based embodiments, any known method or device of programming, storing, interfacing or transmitting may be used to render the invention effectual and in no way should the method or device used be in any way limiting.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed:

1. A method of teaching biological pathways, the method comprising the steps of:
a. providing a learner with:
i. one or more resources,
ii. one or more pathways, and
iii. one or more goals,
b. establishing:
i. an initial amount of the one or more resources,
ii. a cost of the one or more resources needed to operate the one or more pathways,
iii. a product of the one or more pathways, and
iv. an effect the one or more pathways on the one or more goals,
c. allowing the leaner to allocate the one or more resources to the one or more pathways, and
d. providing feedback to the learner regarding the one or more goals as a result of the learner's allocation of the one or more resources.

2. The method of claim 1, further comprising the step of:
e. adjusting the initial amount of the one of more resources based on the learner's allocation of the one or more resources to provide a resulting amount of one or more resources.

3. The method of claim 2, further comprising the step of:
f. adjusting the initial amount of the one or more resources based on a product of the one or more pathways.

4. The method of claim 3, wherein steps a-f are repeated a predetermined number of times.

5. The method of claim 1, further comprising the step of donating points to a learner when the learner achieves the one or more goals.

6. The method of claim 1, wherein the one or more pathways are organized into types.

7. The method of claim 6, wherein the types are selected from the group comprising: global, brain, liver, muscle, or adipose.

8. The method of claim 1, wherein the one or more goals are selected from the group comprising: protein synthesis, RNA synthesis, glycogen synthesis, ions pumped, muscles contracted, or TAG synthesis.

9. The method of claim 1, wherein the one or more resources are selected from the group comprising: nutrients, sugars, amino acids, fatty acids, O₂, CO₂, H₂O, light, ADP, ATP, Pi, NAD+, NADH, FAD, FADH2,NADP+, NADPH, HS-Coenzyme A, acetyl-S-CoA, G-6-P, glycerol-3-P, palmitate-S-CoA, tri-acyl-glyceride, pyruvate, or R-5-P.

10. A system for teaching biological pathways, the system comprising a computer readable medium or media having stored thereon instructions suitably programmed to establish:
i. an initial amount of one or more resources,
ii. a cost of the one or more resources needed to operate one or more pathways,
iii. a product of one or more pathways, and
iv. an effect the one or more pathways on one or more goals.

11. The system of claim 10, wherein the computer readable medium or media is connected to a server.

12. The system of claim 10, further comprising means for allowing a leaner to allocate the one or more resources to the one or more pathways.

13. The system of claim 12, further comprising instructions suitably programmed to provide feedback to the learner regarding the one or more goals as a result of the learner's allocation of the one or more resources.

14. The system of claim 12, wherein the learner can allocate resources remotely from the computer readable medium or media.

15. The system of claim 12, wherein the learner can allocate resources wirelessly.

16. The system of claim 10, wherein the one or more pathways are organized into types.

17. The system of claim 16, wherein the types are selected from the group comprising: global, brain, liver, muscle, or adipose.

18. The system of claim 10, wherein the one or more goals are selected from the group comprising: protein synthesis, RNA synthesis, glycogen synthesis, ions pumped, muscles contracted, or TAG synthesis.

19. The system of claim 10, wherein the one or more resources are selected from the group comprising: nutrients, sugars, amino acids, fatty acids, O₂, CO₂, H₂O, light, ADP, ATP, Pi, NAD+, NADH, FAD, FADH2, NADP+, NADPH, HS-Coenzyme A, acetyl-S-CoA, G-6-P, glycerol-3-P, palmitate-S-CoA, tri-acyl-glyceride, pyruvate, or R-5-P.

20. The method of claim 1, wherein the one or more resources, the one or more products, the one or more pathways, or the one or more goals are represented by or on one or more physical objects, such as cards, tokens, models, and the like.
